(19) United States
(12) Patent Application Publication
(10) Pub. No.: US 2026/0121207 A1
(43) Pub. Date: Apr. 30, 2026

(54) Pressure Equalising Device and Test Method

(71) Applicant: Illinois Tool Works Inc., Glenview, IL (US)

(72) Inventors: Maxence Trap, L’Isle Adam (FR); Massimo Savi, Biella (IT); Carlo Gambino, Bra (IT)

(21) Appl. No.: 19/373,361

(22) Filed: Oct. 29, 2025

(30) Foreign Application Priority Data
Oct. 31, 2024 (EP) 24306841.8
Feb. 5, 2025 (EP) 25315037.9
Jul. 11, 2025 (EP) 25306122.0
Oct. 8, 2025 (DE) 102025141111.5

(51) Int. Cl. H01M 50/317

(52) U.S. Cl. CPC H01M 50/317

(57) ABSTRACT

The application discloses a pressure equalizing device (100, 400) for a battery box (202). The pressure equalizing device comprises: a cage (102, 402) for attachment to a valve opening (210) in the battery box, the cage defining a fluid passage (104, 404) for movement of gas between an inside of the battery box and an outside of the battery box; a valve element (106, 406) covering the fluid passage, and a spring (108) arranged to urge the valve element against the cage so as to close the fluid passage and such that the valve element is moveable to an open configuration when an internal pressure inside the battery box exceeds a threshold pressure. The valve element comprises a breathing opening (138, 438) and a breathable membrane (112, 412) covering the breathing opening. A test method and apparatus is also presented.

### RELATED APPLICATIONS

The present application claims the benefit of European Patent Application No. EP24306841.8, filed Oct. 31, 2024, European Patent Application No. 25315037.9, filed Feb. 5, 2025, European Patent Application No. 25306122.0, filed Jul. 11, 2025, and German Patent Application No. 10 2025 141 111.5, filed Oct. 8, 2025, each titled “Pressure Equalizing Device and Test Method,” the contents of which are hereby incorporated by reference.

### TECHNICAL FIELD

The disclosure described herein relates to a pressure equalizing device for a battery box, in particular a battery box of an electric or hybrid vehicle. The pressure equalizing device includes a breathable membrane for gas exchange in normal operating conditions of the battery box, and a vent opening that opens if the internal pressure of the battery box exceeds a threshold pressure. A test method and apparatus are also disclosed.

### BACKGROUND

Batteries in electric vehicles must be adequately protected from impact damage and environmental ingress. However, this must be tempered with mitigation of risk of battery degradation and/or failure of the battery. Batteries that have failed and/or are degrading can release fluids (including gases) that must be allowed to escape both the battery and any battery protection. There is therefore a tension between providing sufficient protection and allowing fluid exchange.

### SUMMARY

The present disclosure relates generally to a pressure equalizing device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 shows a first example pressure equalizing device.

FIG. 2A shows a cross-section of the pressure equalizing device of FIG. 1 with the valve element in a closed position.

FIG. 2B shows a cross-section of the pressure equalizing device of FIG. 1 with the valve element in an open position.

FIG. 3A shows a perspective cross-section of the pressure equalizing device of FIG. 1 with the valve element in an open position.

FIG. 3B shows a perspective cross-section of the pressure equalizing device of FIG. 1 with the valve element in an open position.

FIG. 4A shows a second example pressure equalizing device from a first perspective view.

FIG. 4B shows a second example pressure equalizing device from a second perspective view.

FIG. 5 shows a cross-section of the pressure equalizing device of FIG. 4A and FIG. 4B.

FIG. 6 shows an example pressure equalizing assembly having two pressure equalizing devices, the pressure equalizing assembly shown in exploded assembly view.

FIG. 7A shows an outer side of the pressure equalizing assembly of FIG. 6.

FIG. 7B shows an inner side of the pressure equalizing assembly of FIG. 6.

FIG. 8 shows a pressure equalizing device arranged upon a battery box and engaged with a leak probing device.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The disclosure is per the appended claims. According to the disclosure there is provided a pressure equalizing device for a battery box, the pressure equalizing device comprising: a cage for attachment to a valve opening in the battery box, the cage defining a fluid passage for movement of gas between an inside of the battery box and an outside of the battery box; a valve element covering the fluid passage, and a spring arranged to urge the valve element against the cage so as to close the fluid passage and such that the valve element is moveable to an open configuration when an internal pressure inside the battery box exceeds a threshold pressure, wherein the valve element comprises a breathing opening and a breathable membrane covering the breathing opening. In this way the pressure equalizing device can prevent environmental ingress, but allow escape of any fluid build up within the battery box.

Suitably, the cage comprises a flange against which the valve element engages in a closed configuration. The flange may be configured to abut an external surface of the battery box and the cage may comprise one or more clips that extend through the valve opening in the battery box and engage an internal surface of the battery box so as to secure the pressure equalizing device to the battery box. In this way the pressure equalizing device can be easily installed on a battery box. Preferably, the one or more clips may extend from the flange and/or the flange may comprise a mounting plate for mounting to the battery box.

Appositely, the cage may comprise a hub portion and one or more arms securing the hub portion to the flange. Optionally, the hub portion comprises a tubular body having an opening to receive a shaft of the valve element, and wherein the spring may be located within the tubular body.

Suitably, the flange comprises a seal, and optionally the seal may be arranged between the flange and the external surface of the battery box in use to provide a seal against environmental ingress. The seal may be arranged on the flange and provide a sealing surface for the valve element.

Preferably, the breathing opening and the breathable membrane extend across less than 20% of the surface area of the valve element.

Appositely, the valve element is circular, and the breathing opening and the breathable membrane are arcuate, for example shaped as a segment of an annulus.

Alternatively, the valve element is circular, and the breathable membrane is circular and centrally aligned with the valve element.

Suitably, a cover may be attached to the valve element that extends across the breathing opening and the breathable membrane, the cover defining a membrane fluid passage for fluid communication between the external ambient environment and an external surface of the breathable membrane. Optionally the cover extends only over the breathable membrane.

In a further part of the disclosure there is provided a method for testing whether a battery box is liquid tight. The battery box having a pressure equalizing device as described above. The method comprises: gripping a valve element of the pressure equalizing device, opening the valve opening by overriding a spring of the pressure equalizing device, and testing for a liquid-leak.

In a still further part of the disclosure there is provided a leak probing device, suitable for conducting the above method. The leak probing device comprises: a test body sized to form a fluid-tight seal about a pressure equalizing device, a test seal arranged upon the test body to form a fluid-tight seal to a pressure equalizing device, a gripper arranged to grip a valve element of a pressure equalizing device, and optionally wherein the gripper comprises a piston, and/or the test body is sized to form a fluid tight seal on the pressure equalizing device, or the test body is sized to form a fluid tight seal over the pressure equalizing device.

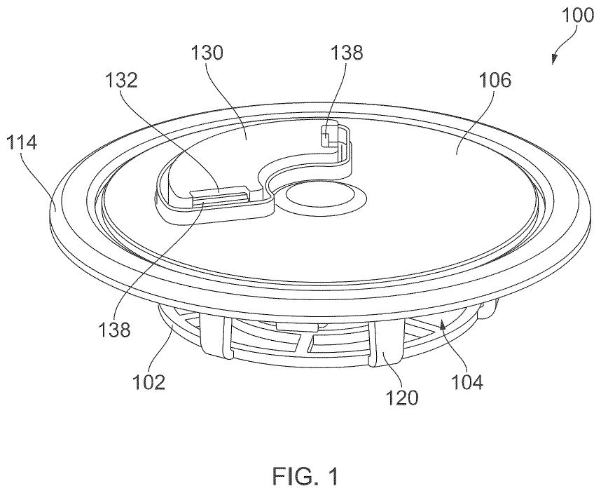

FIG. 1 shows a pressure equalizing device 100 for a battery box. The battery box may be a battery box of an electric or hybrid vehicle. The battery box contains a plurality of battery cells. The battery box provides a substantially sealed container in which the battery cells and other components are housed. As described further below, the pressure equalizing device 100 is provided in a wall of the battery box and provides for gas exchange between the interior and exterior of the battery box in normal operation, to allow breathing and pressure equalisation in normal operation. In the event of a battery malfunction, for example thermal runaway in one or more battery cells, the pressure equalizing device 100 forms a vent opening for venting gasses from the interior to the exterior of the battery box.

Specifically, the pressure equalizing device 100 is configured to allow pressure equalisation between an interior of the battery box and an exterior of the battery box in two modes: in a first mode a breathable membrane 112 permits gas exchange in normal operation, and in a second mode the pressure equalizing device 100 opens a further fluid passage that permits higher rate gas exchange to vent higher pressure gasses from within the battery box.

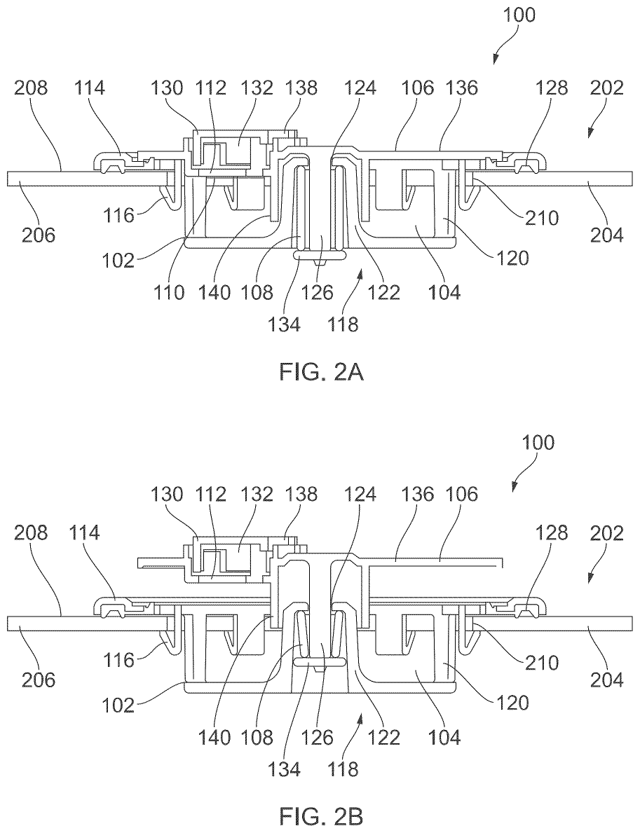

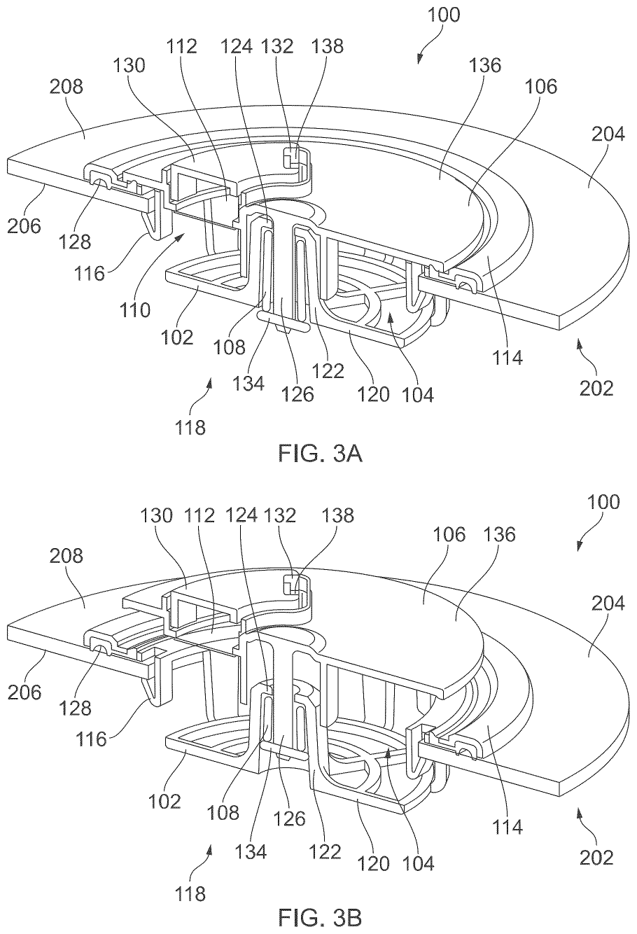

As shown in FIG. 1 the pressure equalizing device 100 has a cage 102 for attachment to a valve opening of the battery box (illustrated in FIG. 2A to FIG. 3B). The cage 102 defines a fluid passage 104 for movement of gas between an interior of the battery box and an exterior of the battery box.

The pressure equalizing device 100 includes a valve element 106 covering the fluid passage 104. A spring 108 is arranged to urge the valve element 106 against the cage 102 so as to close the fluid passage 104. The valve element 106 is moveable, against the force of the spring 108, to an open configuration when an internal pressure inside the battery box exceeds a threshold pressure, for venting the internal pressure. When the valve element 106 is in the open configuration it forms a vent allowing gasses to be vented from the interior of the battery box to the exterior.

The valve element 106 also comprises an opening 110 and a breathable membrane 112 covering the opening 110. An interior side of the breathable membrane 112 is in communication with the fluid passage 104 such that the breathable membrane 112 defines a boundary between the interior and exterior of the battery box. The breathable membrane 112 is configured to equalise, in use, the internal pressure inside the battery box with an ambient pressure outside the battery box.

FIG. 2A, FIG. 2B, FIG. 3A and FIG. 3B show the pressure equalizing device 100 mounted to the battery box 202. In particular, the pressure equalizing device 100 is mounted in a valve opening 210 formed in a wall 204 of the battery box 202. The wall 204 includes an internal surface 206 and an external surface 208.

FIG. 2A and FIG. 3A show the pressure equalizing device 100 in the normal, closed configuration. FIG. 2B and FIG. 3B show the pressure equalizing device 100 in an open configuration. The pressure equalizing device 100 moves into the open configuration in response to an internal pressure of the battery box 202 exceeding a threshold pressure.

With reference to FIG. 1 to FIG. 3B, the cage 102 includes a flange 114 that, in use, abuts the external surface 208 of the wall 204 of the battery box 202 about the valve opening 210. The cage 102 also includes a hub portion 118 that is located centrally with respect to the flange 114 and which extends into the battery box 202. The hub portion 118 is connected to the flange 114 via arms 120. The arms 120 are spaced apart such that a fluid passage 104 is defined through the cage 102 for flow of gasses.

The cage 102 includes clips 116 that extend through the valve opening 210. The clips 116 engage the internal surface 206 of the wall 204 to securely connect the cage 102 (and the pressure equalizing device 100) to the battery box 202, within the valve opening 210. In this example the clips 116 extend from the flange 114, but in other examples the clips 116 may extend from the arms 120 of the cage 102.

In this example the pressure equalizing device 100 has an outer circular form, the flange 114 is circular, and the hub portion 118 is centrally located relative to the flange 114. However, in other examples the shape may be non-circular, such as oval, square or triangular, and the hub portion 118 may be non-centrally located.

The valve element 106 includes a sealing plate 136 and a shaft 126 extending from the sealing plate 136. The valve element 106 also includes a tubular extension 140 that extends about the shaft 126.

The hub portion 118 of the cage 102 includes a tubular body 122 with an opening 124 at the end facing the exterior of the battery box 202 to receive the shaft 126 of the valve element 106. The tubular body 122 is received within the tubular extension 140 extending from the valve element 106. The tubular body 122 and tubular extension 140 may help to guide or restrict movement of the valve element 106 relative to the cage 102. An end stop 134 is provided on an inner end of the shaft 126 and a spring 108 is disposed within the tubular body 122. The spring 108 is a compression spring. The spring 108 is retained between the end stop 134 and the end of the tubular body 122 about the opening 124.

In this way, the spring 108 urges the valve element 106 into a closed position, as shown in FIG. 2A and FIG. 3A. In the closed position the valve element 106, in particular the sealing plate 136, is urged against the flange 114, and in particular against a seal 128 provided in the flange 114. In particular, the valve element 106 is urged against the flange 114 on externally to the battery box 202. The valve element 106 is urged towards the wall 204 of the battery box 202 such that it abuts an outer surface of the flange 114. In this position the valve element 106 closes the fluid passage 104.

As illustrated, the seal 128 may additionally act between the flange 114 and the external surface 208 of the wall 204, or separate seals may be provided.

The valve element 106 is a rigid construction, for example made from a polymer. The cage 102 is also a rigid construction, for example made from a polymer or a metal.

As illustrated, the valve element 106 further includes an opening 110 that extends through the sealing plate 136. The opening 110 is covered by a breathable membrane 112. The breathable membrane 112 may be adhered or welded to the sealing plate 136, or may be co-moulded with the sealing plate 136.

The breathable membrane 112 permits gas exchange through the sealing plate 136 during normal operating conditions, to provide a breathing function for the battery box 202. The breathable membrane 112 is preferably permeable to gas, in particular air, and impermeable to fluids such as water and particles such as dirt. In this way, the breathable membrane 112 permits breathing of the battery box 202 to maintain an ambient operating pressure, while preventing fluid and dirt from entering the battery box 202.

A cover 130 is provided on the valve element 106, extending over the opening 110 and breathable membrane 112. The cover 130 is on an external surface of the valve element 106. The cover 130 is attached to valve element 106, in particular the sealing plate 136. The cover 130 may be adhered or welded to the valve element 106 or may clip into the valve element 106. The valve element 106 may include a securing structure, for example a clip structure, to which the cover 130 is attached. The securing structure may also provide a surface or recess for mounting of the breathable membrane 112. The cover 130 is firmly attached to the valve element 106 and is not moveable relative to the valve element 106. The cover 130 includes a membrane fluid passage 132 that extends from the outside of the breathable membrane 112 to a breathing opening 138 that opens to the external environment. As shown in FIG. 1, the cover 130 may have two breathing openings 138. The cover 130 thereby protects the breathable membrane 112 while permitting gas exchange between the interior and exterior of the battery box 202.

During normal operation of the battery box 202 the breathable membrane 112 permits gas exchange between the interior of the battery box 202 and the external environment, for equalizing pressure.

When an internal pressure of the battery box 202 exceeds a threshold pressure sufficient to compress the spring 108 the valve element 106 is moved to an open configuration, as shown in FIG. 2B and FIG. 3B. In this position the sealing plate 136 is spaced from the flange 114 forming a vent through which fluid (gasses) can be vented from the battery box 202 through the fluid passage 104. In this configuration, gasses can be vented at a high rate due to the vent formed by moving the sealing plate 136. The spring force of the spring 108 may be selected such that the valve element 106 moves to the open position at a predetermined internal pressure of the battery box 202, which may be based on modelling of battery cell thermal runaway or other safety factors.

When the valve element 106 moves into the open configuration the breathable membrane 112 and cover 130 move with the valve element 106.

When the internal pressure of the battery box 202 returns to a pressure below the threshold pressure, the spring 108 moves the valve element 106 back into a sealing position, closing the vent.

As shown most clearly in FIG. 1, FIG. 3A and FIG. 3B, the opening 110, breathable membrane 112 and cover 130 extend across only a part of the valve element 106. In particular, the opening 110, breathable membrane 112 and cover 130 extend over only a part of the sealing plate 136. In examples, the opening 110, breathable membrane 112 and cover 130 extend over less than about 50% of the surface area of the sealing plate 136, preferably less than about 40%, or less than about 30%, or less than about 20%.

In examples, as shown, the opening 110, breathable membrane 112, and cover 130 may have an arcuate shape. The arcuate shape may have a diameter that matches the diameter of the circular sealing plate 136. The opening 110, tubular body 122 and cover 130 may form a segment of an annulus on the sealing plate 136. The cover 130 only extends across a part of the valve element 106 (sealing plate 136), in particular the cover 130 only extends across the part of the valve element 106 where the breathable membrane 112 is provided.

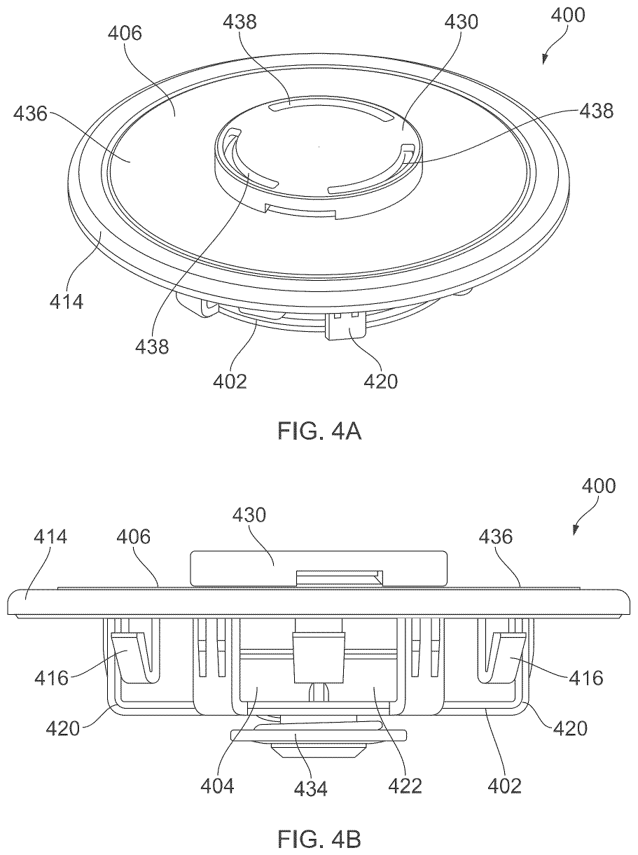

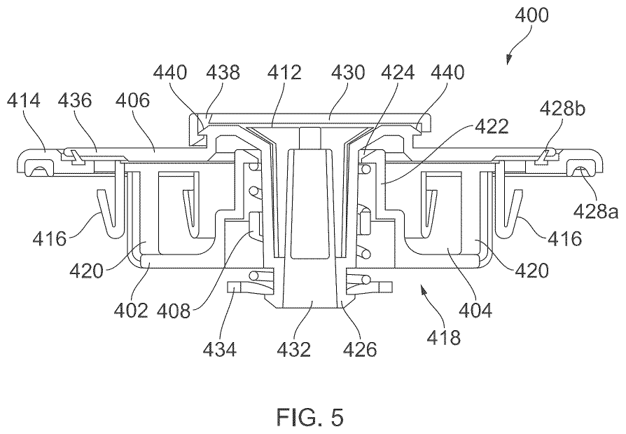

FIG. 4A to FIG. 5 illustrate a further example pressure equalizing device 400. The pressure equalizing device 400 of this example is similar to that of FIG. 1 to FIG. 3B. In particular, as illustrated, as with the pressure equalizing device 100 described above, the pressure equalizing device 400 includes a cage 402 and a valve element 406 that is movably mounted to the cage 402 and a spring 408 that urges the valve element 406 against a flange 414 of the cage 402, which includes a seal 428b against which the valve element 406 forms a seal to close the fluid passage 404.

The flange 414 also includes a seal 428a arranged to seal against a housing to which the pressure equalizing device 400 is mounted. The valve element 406 includes arms 420 that connect the flange 114 to a hub portion 418, and clips 416 for attaching the pressure equalizing device 400 in an opening of a housing.

The hub portion 418 defines a tubular body 422 and an opening 424 in which the valve element 406 is slidably received. The valve element 406 includes a sealing plate 436 that engages the flange 414 and shaft 426 extending from the sealing plate 436, through the opening 424 and into the tubular body 422. The valve element 406 includes an end stop 434 at an end opposite to the sealing plate 436 and the spring 408 acts between the end stop 434 and a part of the tubular body 422.

The valve element 406 also has a breathable membrane 412 mounted to the sealing plate 436, and a membrane fluid passage 432 is defined through the shaft 426 of the valve element 406 to permit breathing through the breathable membrane 412.

In this example, in contrast to the example of FIG. 1 to FIG. 3B, the breathable membrane 412 is centrally located on the valve element 406. As shown, the sealing plate 436 is circular, and the breathable membrane 412 is circular and aligned with a centre of the sealing plate 436. A cover 430 is provided, and the cover 430 is also centrally located on the valve element 406 to cover the breathable membrane 412. The cover 430 is circular. The cover 430 includes one or more breathing openings breathing opening 438. As shown in FIG. 5, the valve element 406 and the cover 430 are connected at a snap-fit connection 440.

The seal of the flange 414 of this example comprises two parts-a first seal 428a that protrudes on an outer side of the flange 414 to form a lip seal that is engaged by the sealing plate 436, and a second seal 428b that protrudes on an inner side of the flange 414 to engage the housing to which the pressure equalizing device 400 is mounted. The seal 428a, 428b is preferably formed by two-shot injection moulding (2 k moulding) a softer polymer with the more rigid polymer of the body of the cage 402. Moulding channels may connect the seal 428a and the seal 428b through a part of the flange 414.

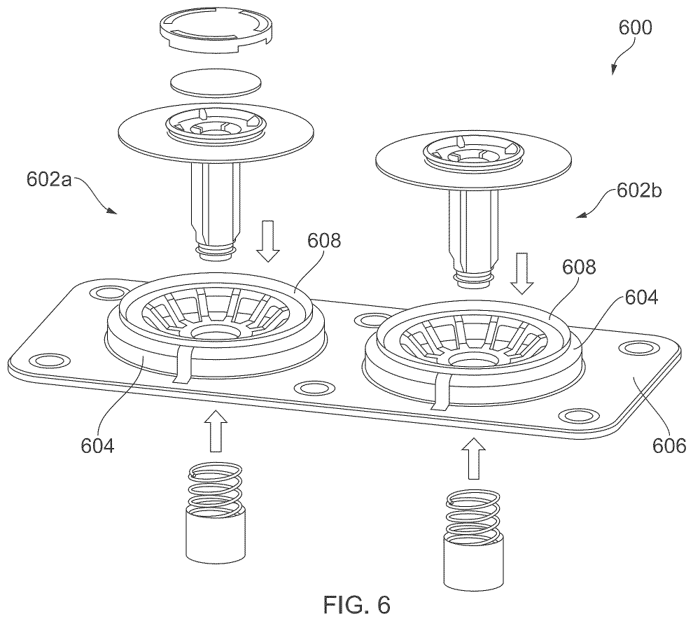

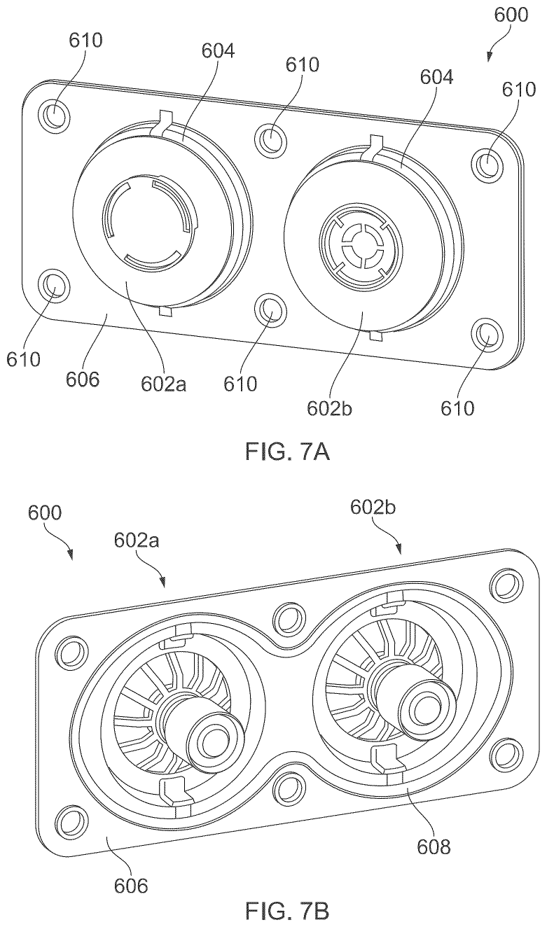

FIG. 6 to FIG. 7B illustrate a pressure equalizing assembly 600 that includes two pressure equalizing devices—a first pressure equalizing device 602a and a second pressure equalizing device 602b.

In various examples the first pressure equalizing device 602a and the second pressure equalizing device 602b may both be the pressure equalizing device 100 or the pressure equalizing device 400 described above, or the first pressure equalizing device 602a may be the pressure equalizing device 100 and the second pressure equalizing device 602b may be the pressure equalizing device 400, or vice versa.

In these examples the pressure equalizing assembly 600 advantageously provides a higher degassing rate than a single pressure equalizing device, and a higher breathing rate. This may be useful for larger battery assemblies. The arrangement of two pressure equalizing devices may maintain a narrow outer form than a single, larger pressure equalizing device, which may be beneficial for mounting the pressure equalizing assembly 600 to a battery assembly.

In another example, as illustrated, the first pressure equalizing device 602a comprises the pressure equalizing device 400 described above, and the second pressure equalizing device 602b comprises a pressure equalizing device similar to that of FIG. 4A to FIG. 5 described above, but without a breathable membrane. Instead, a sealing plate is provided in place of the breathable membrane, and no cover is provided. In this example the first pressure equalizing device 602a provides a breathing function, and both the first pressure equalizing device 602a and the second pressure equalizing device 602b provide for degassing in higher pressure situations.

In examples, both the first pressure equalizing device 602a and the second pressure equalizing device 602b have the same opening pressure (e.g., the same area of the valve element and the same spring). Therefore, both the first pressure equalizing device 602a and the second pressure equalizing device 602b would open at the same pressure to provide degassing.

In other examples the first pressure equalizing device 602a may have a different opening pressure than the second pressure equalizing device 602b, for example due to having a different size and/or spring. This may provide a first rate of degassing at a first pressure at which only the first pressure equalizing device 602a is opened, and a second rate of degassing at a higher pressure at which both the first pressure equalizing device 602a and the second pressure equalizing device 602b are opened.

As illustrated, the first pressure equalizing device 602a and the second pressure equalizing device 602b are mounted to a mounting plate 606. The flanges 604 and seals 608 of the first pressure equalizing device 602a and second pressure equalizing device 602b are integrated into the mounting plate 606. The cages are also integrally formed with the mounting plate 606. As shown most clearly in FIG. 7B, the seal 608 may be moulded with the mounting plate 606 by two-shot injection moulding, and parts of the seal 608 extend between the two flanges 604 to enable or simplify the two-shot injection moulding. The valve elements and springs of the first pressure equalizing device 602a and second pressure equalizing device 602b are attached to the cages as described above with reference to earlier examples.

The mounting plate 606 includes mounting holes 610 for attaching the mounting plate 606 to the housing (e.g., battery box). The clips 116, 416 of the earlier examples may not be provided as they are not needed for attaching the pressure equalizing assembly 600 to the housing (battery box). Stiffening ribs may be added to the valve element to ensure the valve makes a sealing contact. An additional ingress prevention cover may be provided which shields the pressure equalizing device from being directly sprayed with water in e.g. an automated vehicle wash.

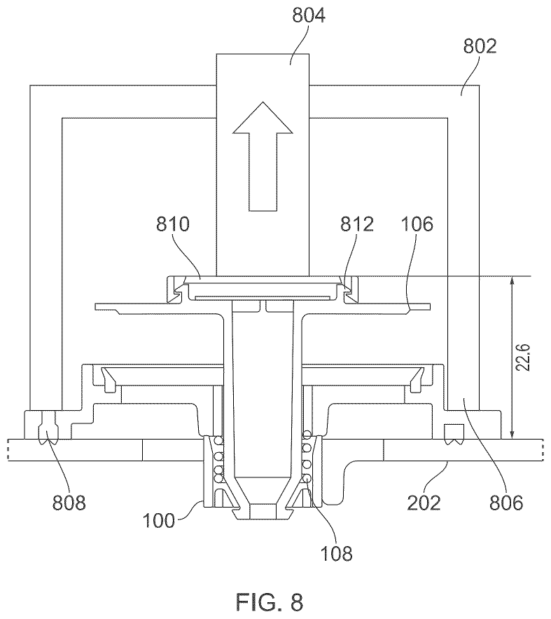

FIG. 8 shows a pressure equalizing device 100, 400 arranged upon a battery box 202 and engaged with a leak probing device 802. The leak probing device 802 is arranged to open the pressure equalizing device and to test fluid-tightness of the battery box 202 (e.g. To check if water ingress is possible, or if the battery box 202 is otherwise compromised and at risk of contaminant ingress from the environment). In FIG. 8, the pressure equalizing device is labelled using 100 series numbers, however any pressure equalizing device disclosed in this application may be substituted, or the teachings of this disclosure applied to any suitable pressure equalizing device. The use of 100 series numbers is not intended to be limiting, but instead to improve clarity of the figure by omitting other reference numerals which may otherwise obfuscate the figure.

The leak probing device 802 is intended to form part of a production line and to test battery box 202 as described above. The method for tests whether a battery box 202 is liquid-tight.

The method comprises gripping a valve element 106, 406 of a pressure equalizing device, opening the valve opening 210 by overriding a bias that is arranged to place the valve element in a closed position (e.g. A spring 108, 408, by way of non-limitative example), and then testing for a liquid-leak (e.g. By applying a vacuum or otherwise looking for a pressure differential).

The method may further comprise forming a test seal on or about a pressure equalizing device. It will be appreciated that either arrangement will test different parts, such as including the seal between the pressure equalizing device and the battery box or excluding that seal.

The method may include assembling the leak probing device 802 upon the pressure equalizing device, for example at an appropriate stage of production.

In the method, gripping a valve element may be facilitated via a piston 804 that is arranged to move between positions proximate to and remote from the pressure equalizing device. Likewise, the method may also involve disengaging a grip from a valve element, for example, once testing is complete (although disengagement may form part of the method at other times). Where disengagement occurs, the method may include closing the valve opening, such that the pressure equalizing device is returned to an “in use” state.

The method may include disassembling the leak probing device from the pressure equalizing device so that a production process may continue for example.

As discussed above, testing for a liquid-leak may comprises measuring a pressure differential. Here “liquid” may typically refer to water, but the liquid-leak tested for may be any suitable liquid (such as oil). It will be apparent that test outcome and acceptable parameters may vary depending on the particular liquid.

As per the above, FIG. 8 shows a leak probing device 802 that is suitable for conducting the above described method. The leak probing device comprises a test body 806, suitable to form a fluid tight seal to the battery box 202/pressure equalizing device. The test body 806 is therefore sized to form a fluid-tight seal about a pressure equalizing device. A test seal 808 is provided and arranged upon the test body in order to form a fluid-tight seal to a pressure equalizing device.

A gripper 810 is arranged to grip a valve element 106 of a pressure equalizing device 100. The gripper can be any suitable to form a reversible grip to the valve element 106 and allow the valve to be placed into an open position in order for the above method to be performed. Example grippers may include bayonet fixations, treaded bars/apertures, snap fit fixations, resilient lips and/or clips. It may preferable that the gripper 810 may grip the valve element 106 by merely being pressed against the valve element 106 (i.e. without rotating the gripper). The gripper may comprise a piston to allow the gripper to be placed in proximity to, and/or bear upon, the valve element 106.

The test body 806 may be sized to form a fluid tight seal on the pressure equalizing device, or the test body may be sized to form a fluid tight seal over (i.e. To the battery box 202 and not the pressure equalizing device) the pressure equalizing device.

It will be apparent that a pressure equalizing device may be suitable for use with the method above and/or the leak probing device above, when the pressure equalizing device comprises a valve element comprising a grip feature 812 arranged to be gripped by a gripper. The grip feature 812 may be any suitable to be gripped by the grippers 810 (i.e. It need not be complementary, but merely compatible). The grip feature 812 may therefore be any suitable ridge, trench, resilient lip, resilient clip, threaded bar or aperture, bayonet socket, by way of non-limitative example.

Further embodiments of the disclosure are made in the below clauses, which are not to be confused with the claims:

Clause 1. A pressure equalizing device for a battery box, the pressure equalizing device comprising: a cage for attachment to a valve opening in the battery box, the cage defining a fluid passage for movement of gas between an inside of the battery box and an outside of the battery box; a valve element covering the fluid passage, and a spring arranged to urge the valve element against the cage so as to close the fluid passage and such that the valve element is moveable to an open configuration when an internal pressure inside the battery box exceeds a threshold pressure, wherein the valve element comprises a breathing opening and a breathable membrane covering the breathing opening.

Clause 2. The pressure equalizing device of clause 1, wherein the cage comprises a flange against which the valve element engages in a closed configuration.

Clause 3. The pressure equalizing device of clause 2, wherein the flange is configured to abut an external surface of the battery box and the cage comprises one or more clips that extend through the valve opening in the battery box and engage an internal surface of the battery box to secure the pressure equalizing device to the battery box.

Clause 4. The pressure equalizing device of clause 2, wherein the one or more clips extend from the flange.

Clause 5. The pressure equalizing device of clause 2, wherein the flange comprises a mounting plate for mounting to the battery box.

Clause 6. The pressure equalizing device of any previous clause 2, wherein the cage comprises a hub portion and one or more arms securing the hub portion to the flange.

Clause 7. The pressure equalizing device of clause 6, wherein the hub portion comprises a tubular body having an opening to receive a shaft of the valve element, and wherein the spring is located within the tubular body.

Clause 8. The pressure equalizing device of any one of clauses 2 to 7, wherein the flange comprises a seal.

Clause 9. The pressure equalizing device of clause 6, wherein the seal is arranged between the flange and the external surface of the battery box in use, and/or wherein the seal is arranged on the flange and provides a sealing surface for the valve element.

Clause 10. The pressure equalizing device of any one of clauses 1 to 9, wherein the breathing opening and the breathable membrane extend across less than 20% of the surface area of the valve element.

Clause 11. The pressure equalizing device of any one of clauses 1 to 10, wherein the valve element is circular, and the breathing opening and the breathable membrane are arcuate, for example shaped as a segment of an annulus.

Clause 12. The pressure equalizing device of any one of clauses 1 to 10, wherein the valve element is circular, and the breathable membrane is circular and centrally aligned with the valve element.

Clause 13. The pressure equalizing device of any one of clauses 1 to 12, further comprising a cover attached to the valve element and extending across the breathing opening and the breathable membrane, the cover defining a membrane fluid passage for fluid communication between the external ambient environment and an external surface of the breathable membrane.

Clause 14. The pressure equalizing device of clause 2, wherein the cover extends only over the breathable membrane.

Clause 15. The pressure equalizing device of any one of clauses 1 to 14, wherein the cage and/or the valve element comprise a rigid material, for example a polymer or metal.

Clause 16. A pressure equalizing assembly comprising a mounting plate, a first pressure equalizing device and a second pressure equalizing device, the first and second pressure equalizing devices being located on the mounting plate.

Clause 17. The pressure equalizing assembly of clause 2, wherein the mounting plate comprises a seal, and wherein the seal is integrally moulded with the mounting plate, for example by two-shot injection moulding.

Clause 18. A method for testing whether a battery box (202), having a pressure equalizing device (100, 400), is liquid-tight, the method comprising: gripping a valve element (106, 406) of a pressure equalizing device, opening the valve opening (210) by overriding a spring (108, 408) of the pressure equalizing device, and testing for a liquid-leak.

Clause 19. The method of clause 18, further comprising forming a test seal on or about a pressure equalizing device; and/or assembling a leak probing device (802) upon a pressure equalizing device; and/or wherein gripping a valve element is via a piston (804); and/or disengaging a grip from a valve element; and/or closing the valve opening; and/or disassembling a leak probing device from a pressure equalizing device; and/or wherein testing for a liquid-leak comprises measuring a pressure differential.

Clause 20. A leak probing device, suitable for conducting the method of clause 18 or clause 19, the leak probing device comprising: a test body (806) sized to form a fluid-tight seal about a pressure equalizing device, a test seal (808) arranged upon the test body to form a fluid-tight seal to a pressure equalizing device, a gripper (810) arranged to grip a valve element of a pressure equalizing device, and optionally wherein the gripper comprises a piston, and/or the test body is sized to form a fluid tight seal on the pressure equalizing device, or the test body is sized to form a fluid tight seal over the pressure equalizing device.

Clause 21. A pressure equalizing device suitable for use with the method of any of clauses 18 or 19, or the leak probing device of clause 20, wherein the pressure equalizing device comprises a valve element, the valve element comprising a grip feature arranged to be gripped by a gripper.

In contrast to other pressure equalizing devices the pressure equalizing devices 100, 400 and the pressure equalizing assembly 600 described above have a low profile extending outwardly from the battery box 202. The restricted size of the cover 130, 430, which is only provided over the breathable membrane 112, 412, reduces the height and width of the cover 130, 430 and therefore reduces the profile of the pressure equalizing device 100, 400, 600 extending outwardly of the battery box 202. This may enable the pressure equalizing device 100, 400 to be provided in more confined spaces around the battery box 202.

Moreover, the attachment of the pressure equalizing device 100, 400 to the battery box 202, via the clips 116, 416, provides for ease of assembly of the pressure equalizing device 100, 400 to the battery box 202.

While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A pressure equalizing device (100, 400) for a battery box (202), the pressure equalizing device comprising: a cage (102, 402) for attachment to a valve opening (210) in the battery box, the cage defining a fluid passage (104, 404) for movement of gas between an inside of the battery box and an outside of the battery box; a valve element (106, 406) covering the fluid passage, and a spring (108) arranged to urge the valve element against the cage so as to close the fluid passage and such that the valve element is moveable to an open configuration when an internal pressure inside the battery box exceeds a threshold pressure, wherein the valve element comprises a breathing opening (138, 438) and a breathable membrane (112, 412) covering the breathing opening.

2. The pressure equalizing device of claim 1, wherein the cage comprises a flange against which the valve element engages in a closed configuration, and optionally wherein:
(a) the flange is configured to abut an external surface of the battery box and the cage comprises one or more clips that extend through the valve opening in the battery box and engage an internal surface of the battery box to secure the pressure equalizing device to the battery box, and/or
(b) the one or more clips extend from the flange, and/or
(c) the flange comprises a mounting plate for mounting to the battery box.

3. The pressure equalizing device of claim 2, wherein the cage comprises a hub portion and one or more arms securing the hub portion to the flange, and optionally wherein the hub portion comprises a tubular body having an opening to receive a shaft of the valve element, and wherein the spring is located within the tubular body.

4. The pressure equalizing device of claim 2, wherein the flange comprises a seal, and optionally wherein
the seal is arranged between the flange and the external surface of the battery box in use, and/or
the seal is arranged on the flange and provides a sealing surface for the valve element.

5. The pressure equalizing device of claim 1, wherein the breathing opening and the breathable membrane extend across less than 20% of the surface area of the valve element.

6. The pressure equalizing device of claim 1, wherein the valve element is circular, and the breathing opening and the breathable membrane are arcuate, for example shaped as a segment of an annulus.

7. The pressure equalizing device of claim 1, wherein the valve element is circular, and the breathable membrane is circular and centrally aligned with the valve element.

8. The pressure equalizing device of claim 1, further comprising a cover attached to the valve element and extending across the breathing opening and the breathable membrane, the cover defining a membrane fluid passage for fluid communication between the external ambient environment and an external surface of the breathable membrane, and optionally wherein
the cover extends only over the breathable membrane.

9. A method for testing whether a battery box (202) is liquid tight, the battery box having a pressure equalizing device (100, 400) according to any previous claim, the method comprising: gripping a valve element (106, 406) of the pressure equalizing device, opening the valve opening (210) by overriding a spring (108, 408) of the pressure equalizing device, and testing for a liquid-leak.

10. A leak probing device, suitable for conducting the method of claim 9, the leak probing device comprising: a test body (806) sized to form a fluid-tight seal about a pressure equalizing device, a test seal (808) arranged upon the test body to form a fluid-tight seal to a pressure equalizing device, a gripper (810) arranged to grip a valve element of a pressure equalizing device, and optionally wherein the gripper comprises a piston, and/or the test body is sized to form a fluid tight seal on the pressure equalizing device, or the test body is sized to form a fluid tight seal over the pressure equalizing device.
